(19) United States
(12) Patent Application Publication
(10) Pub. No.: US 2023/0185974 A1
(43) Pub. Date: Jun. 15, 2023

(54) DESIGN AND OPTIMIZATION METHOD BASED ON SELF SUPPORTING ELLIPSOIDAL CAVITY STRUCTURE

(71) Applicant: DALIAN UNIVERSITY OF TECHNOLOGY, Dalian, Liaoning (CN)

(72) Inventors: Shengfa WANG, Dalian, Liaoning (CN); Jun YANG, Dalian, Liaoning (CN); Na LEI, Dalian, Liaoning (CN); Zhongxuan LUO, Dalian, Liaoning (CN)

(21) Appl. No.: 17/779,354

(22) PCT Filed: Jul. 16, 2021
(86) PCT No.: PCT/CN2021/106735

§ 371 Date: May 24, 2022

(51) Int. Cl. G06F 30/10; G06F 30/20

(52) U.S. Cl. CPC G06F 30/10; G06F 30/20; G06F 2111/10

(57) ABSTRACT

The present invention discloses a design and optimization method based on a self supporting ellipsoidal cavity structure. First, a three-dimensional model with initialized self supporting ellipsoidal cavities is represented by a function; then the structure of the object is analyzed, modeled and optimized by the continuity and differentiability of the function; the internal lightweighting of the model is carried out with the self supporting ellipsoidal cavities, without the need of adding a supporting structure, thus avoiding waste of materials; the intersection of self supporting ellipsoids is strictly controlled to avoid damage to self supportability within the model due to intersection; and finally, the above modeling problem is geometrically optimized to obtain an internal shape of the object optimized under given constraint conditions. The present invention greatly shortens the design and optimization cycle of the hole structure, realizes self supporting for the internal cavities of the model.

### TECHNICAL FIELD

The present invention belongs to the technical field of computer-aided design, engineering design and manufacturing, and relates to a design and optimization method based on a self supporting ellipsoidal cavity structure, which is applicable to general design and optimization of internal lightweighting of components.

### BACKGROUND

Internal hollowing is an effective lightweighting method, without the need of changing the external shape of a three-dimensional model. This method can greatly reduce the material consumption and manufacturing cost, and is widely used in the fields of environmental protection and material saving. However, in the process of 3D printing, influenced by the viscosity of the printing material and the self gravity of the printing model, an overlong suspended structure or a large overhanging angle on the surface of a region may cause failure of layer-by-layer printing due to insufficient material viscosity. Generally, the above problem can be solved by adding a special supporting structure. If such suspended structure appears outside the model, the added special supporting structure can be removed through post-processing after printing, but a supporting structure added to the internal region of the model cannot be removed or is difficult to remove. More importantly, no matter whether the added supporting structure can be removed or not, the material is wasted, which is contrary to the purpose of model lightweighting, while the self supporting ellipsoids can better solve the problem of the model.

Meanwhile, the existing methods have the problems of local self-intersection, rough shape representation and difficulty in accurately describing the internal complex structure. However, the method for representing a model by a function can avoid the problem of self-intersection, the description of the internal cavity shape of a three-dimensional model is more accurate and more smooth, all the ellipsoids are required to not intersect during target optimization, and the method for representing a model by a function can also be more convenient for calculation.

### SUMMARY

In view of the above problems, the present invention proposes a design and optimization method based on a self supporting ellipsoidal cavity structure. First, a three-dimensional object model with cavities is represented by a function; and then the structure of the object is analyzed, modeled and optimized by the continuity and differentiability of the function directly on the function for more efficient and accurate representation and calculation, and self supporting ellipsoids are used to ensure resistance to the influence of self gravity of the printing model by means of the viscosity of the printing material without the need of adding a supporting structure, thus avoiding waste of materials and achieving the goal of model lightweighting.

Therefore, the method of the present invention realizes self supporting within the model and can ensure that no global and local self intersection problem will occur by adding limiting conditions for intersection of ellipsoids during optimization. As all the processes of the optimization framework are performed directly on the function without the need of meshing processing, the present invention is a more efficient and accurate representation and optimization solution. The method of the present invention is applied to optimization of stress analysis, and can continue optimization of the cavity volume until convergence to the target volume on the premise of ensuring that the internal ellipsoidal structure can realize self supporting and non-intersect without the need of adding a supporting structure, and a larger cavity volume is obtained.

The technical solution of the present invention is as follows:

A design and optimization method based on a self supporting ellipsoidal cavity structure, comprises the following steps:

(I) Shape function representation of three-dimensional model with ellipsoidal cavities: A three-dimensional model with ellipsoidal cavities is represented as ϕ°(p) ≥ 0, wherein ϕ°(p) is a representation function of the model:

$${ϕ}^{o} \left(p\right) = min \left(\overline{ϕ} \left(p\right) , - {\sum }_{i = 1}^{{n}_{e}} \underline{{ϕ}_{i}} \left(p\right)\right)$$

wherein p = (x, y, z) is the coordinate of a point on the model, ϕ̅(p) is an outer surface function of an object,

$$\underline{{ϕ}_{i}} \left(p\right)$$

is an inner surface function of the i ^{th} ellipsoid, and nₑ is the number of ellipsoids.

The above three-dimensional model with ellipsoidal cavities is defined by a global function, thus having the characteristics of continuity, controllability and differentiability, and the subsequent analysis, modeling and optimization of the structure of the object can be directly performed on the function for more efficient and accurate representation and calculation.

(II) Initialization and structure optimization based on self supporting ellipsoidal cavity model For an ellipsoidal cavity model initially generated, the optimization goal is satisfied as far as possible, i.e., the ellipsoidal cavity is larger where the stress is small, reducing internal solid space and material consumption; and the ellipsoidal cavity is smaller where the stress area is large, increasing internal solid space and resisting deformation caused by stress. Meanwhile, the ellipsoidal cavity model initially generated needs further optimization to continue optimization of the cavity volume to the set target volume under the limitation of ensuring that the internal ellipsoidal structure can realize self supporting and non-intersect.

### 1. Initialization of Self Supporting Ellipsoidal Cavity Model

First, a three-dimensional bounding box is built for the model. Then, the inner space of the bounding box is subjected to uniform mesh generation, and the whole three-dimensional space is divided into uniform meshes with K³ mesh points. Each mesh point is taken as an internal initial ellipsoid center for screening. A corresponding ellipsoid radius rₙ(n = 1... K³) is assigned to each ellipsoid center according to the stress value of the region of each internal initial ellipsoid center. To enhance the flexibility when the inner space is initialized so as to make the ellipsoids fill the whole space as much as possible, the ellipsoid radius corresponding to each center point varies within a range.

The ellipsoid radius shall satisfy

$${r}_{n}^{i} ∈ \left[0.5 {r}_{m a x}^{i} , {f}_{m a x}^{i}\right] ,$$

here:

$${\text{r}}_{max}^{\text{i}} = {μ}_{\text{i}} * min \left\{\frac{\text{XMax} - \text{XMin}}{\text{g}} , \frac{\text{YMax} - \text{YMin}}{\text{g}} , \frac{\text{ZMax} - \text{Zmin}}{\text{g}}\right\}$$

wherein XMax, XMin, YMax, YMin, ZMax and ZMin are extreme values of the model in three dimensions; g is a density parameter, used for adjusting the number of internal ellipsoids, as the g value gradually increases, the ellipsoid radius decreases, the number of ellipsoidal cavities in the model increases, and the initial cavity volume increases; and µᵢ is the stress parameter of the point, represented as follows:

$${μ}_{\text{i}} = \frac{1}{{D}_{i} B}$$

wherein B is a strain matrix, Dᵢ is an elastic matrix of the i^{th} unit, Dᵢ = ρᵢD₀, the Young’s modulus D₀ depends on the attributes of the solid material used, and ρᵢ is the density of the i^{th} unit.

### 2. Establishment of Problem Model

For given model stress and boundary conditions, a stress problem model is established as follows:

$${}_{{t}_{k}} min I = {\int }_{{Ω}_{M}} G \left({ϕ}^{o} \left(p\right)\right) F ⋅ u d V + {\int }_{{τ}_{s}} {F}_{s} ⋅ u d S$$

$$s . t . {\int }_{{Ω}_{M}} G \left({ϕ}^{o} \left(p\right)\right) E : ε \left(u\right) : ε \left(v\right) d {V}_{M}$$

$$= {\int }_{{Ω}_{M}} G \left({ϕ}^{o} \left(p\right)\right) f ⋅ v d V + {\int }_{{τ}_{s}} s ⋅ v d V , ∀ \text{} \text{} \text{} v ε {U}_{a d}$$

$$u = \overline{u} , o n {τ}_{u}$$

$${\int }_{{Ω}_{M}} G \left({ϕ}^{o} \left(p\right)\right) d {V}_{M} \leq {V}_{v}$$

wherein

$${t}_{k} = \left\{{a}_{1} , {b}_{1} , {c}_{1} , … , {a}_{{n}_{e}} , {b}_{{n}_{e}} , {c}_{{n}_{e}}\right\} \left(k = 1 , … , 3 {n}_{e}\right)$$

is the set of three axial length variable parameters of an ellipsoid, I is the overall compliance, Ω_{M} is the whole region occupied by the model M, ϕ°(∗) is a representation function of the model, F is a body force, Fₛ is a surface force defined on the Riemann boundary τₛ, S is the area of the Riemann boundary τₛ, u is a displacement field, v is a test function defined on the region Ω_{M}, U_{ad} = {v|v ∈ Sob¹(Ω_{M}), ν = 0 on τᵤ}, Sob¹ is the first order soblev space, ε is the second order linear strain tensor,

$$E$$

is the fourth order elastic tensor, u̅ is a displacement constraint defined on the Dirichlet boundary τᵤ, V_{M} is the volume of the model M, V_{c} is the value of a volume constraint, and G(x) is a regularized Heaviside function.

### 3. Discretization of Problem Model

For optimization of the initialized self supporting ellipsoidal cavity model, the stress problem model can be represented as an optimization model in a discrete form by introducing an auxiliary variable Eₛ for preventing ellipsoids from intersecting into the stress problem model and introducing self supporting conditions into the limiting conditions:

$$min I = {U}^{T} K U + {λ}_{s} {E}_{s}$$

$$\text{s} \text{.t} \text{.} K U = F ,$$

$$\text{V} = {\sum }_{\text{i=1}}^{\text{n}} {\sum }_{\text{j=1}}^{8} \left(G {\left({ϕ}_{i , j}^{o}\right)}^{q}\right) - {\sum }_{\text{i=1}}^{{\text{n}}_{\text{e}}} \frac{4}{3} π {a}_{i} {b}_{i} {c}_{i} \leq \overline{V} ,$$

$$a \left(b\right) \leq c , i f 5 σ \leq a \left(b\right) \leq \frac{{δ}_{0}}{2 c o s {θ}_{0}} ,$$

$$c \geq a \left(b\right) \frac{\sqrt{4 a {\left(b\right)}^{2} - {δ}_{0} {}^{2}}}{{δ}_{0} t a n {θ}_{0}} , i f a \left(b\right) \geq \frac{{δ}_{0}}{2 c o s {θ}_{0}}$$

wherein the purpose of introducing the auxiliary variable Eₛ is to keep the ellipsoids in a non-intersect state during optimization, λₛ is a target weight, U is a displacement matrix, U^{T} is the transposition of the displacement matrix, F is an applied external force, K is the stiffness matrix of the material, which is composed of the stiffness matrix Kᵢ of each unit, G(x) is a regularized Heaviside function, q is a penalty parameter, a(b) are two semi-axes of the ellipsoid in the non-printing direction, c is the semi-axis of the ellipsoid in the print direction, σ is the printing accuracy, δ₀ is the maximum overhanging horizontal length for printing, and θ₀ is the maximum specified overhanging angle.

### 4. Modeling Problem Optimization

Based on the optimization problems established above, the solving algorithm is used for optimization, wherein the variable parameters are the semi-axes

$${\left\{\left({a}_{k} , {b}_{k} , {c}_{k}\right)\right\}}_{k = 1}^{{n}_{e}}$$

of all the ellipsoids, nₑ is the number of the internal ellipsoids, the target function is the overall compliance, and the limiting conditions are self supporting conditions, cavity volume limitations and external force balance of ellipsoids.

$$\begin{matrix}\frac{\partial Ι}{\partial {t}_{k}} = - {U}^{T} \frac{\partial K}{\partial {t}_{k}} U + {λ}_{s} \frac{\partial {E}_{s}}{\partial {t}_{k}} \\ = - {U}^{T} \left[\frac{1}{8} {\sum }_{i = 1}^{n} {\sum }_{j = 1}^{8} q {\left(G \left({ϕ}_{i , j}^{o}\right)\right)}^{q - 1} \frac{\partial G \left({ϕ}_{i , j}^{o}\right)}{\partial {t}_{k}}\right] U + {λ}_{s} \frac{\partial {E}_{s}}{\partial {t}_{k}}\end{matrix}$$

and

$$\frac{\partial V}{\partial {t}_{k}} = {\sum }_{k = 1}^{{n}_{e}} \frac{4}{3} π \frac{{a}_{k} {b}_{k} {c}_{k}}{{t}_{k}}$$

$$\frac{\partial G \left({ϕ}_{i , j}^{o}\right)}{\partial {t}_{k}} = \frac{\partial G}{\partial {ϕ}_{i , j}^{o}} ⋅ \frac{\partial {ϕ}_{i , j}^{o}}{\partial {t}_{k}}$$

$$\frac{\partial {E}_{S}}{\partial {t}_{k}} = \frac{\partial {E}_{S}}{\partial s {r}_{p}} ⋅ \frac{\partial s {r}_{p}}{\partial {A}_{i}} ⋅ \frac{\partial {A}_{i}}{\partial {t}_{k}}$$

wherein λₛ is a target weight, U is a displacement matrix, U^{T} is the transposition of the displacement matrix, K is the stiffness matrix of the material, Eₛ is an auxiliary variable for controlling intersection of ellipsoids, q is a penalty parameter, G(x) is a regularized Heaviside function,

$${ϕ}_{i , j}^{o}$$

is a representation function of the model with ellipsoidal cavities, tₖ is the set of variable parameters:

$${t}_{k} = \left\{{a}_{1} , {b}_{1} , {c}_{1} , … , {a}_{{n}_{e}} , {b}_{{n}_{e}} , {c}_{{n}_{e}}\right\} \left(k = 1 , … , 3 {n}_{e}\right) ,$$

srₚ is the set of intermediate parameters, and Aᵢ is a parameter matrix in the matrix form of the i^{th} ellipsoid. The calculated gradient is substituted into a solver to obtain an optimal value

$${\left\{{t}_{k}\right\}}_{k = 1}^{3 {n}_{3}} ,$$

thus obtaining the final optimization model, i.e., the internal shape of the object optimized under given constraint conditions.

The present invention has the beneficial effects that the designed self supporting ellipsoidal cavity structure has the characteristics of self supportability, higher porosity and easiness for 3D printing to ensure the applicability and the manufacturability of this structure, this self supporting ellipsoidal cavity structure is suitable for the frequently-used 3D printing manufacturing methods, and the internal structure in the printing process has self supportability without the need of additional support, thus saving printing time and printing material.

### DESCRIPTION OF DRAWINGS

FIG. 1 is a flow chart of design and optimization based on a self supporting ellipsoidal cavity structure.

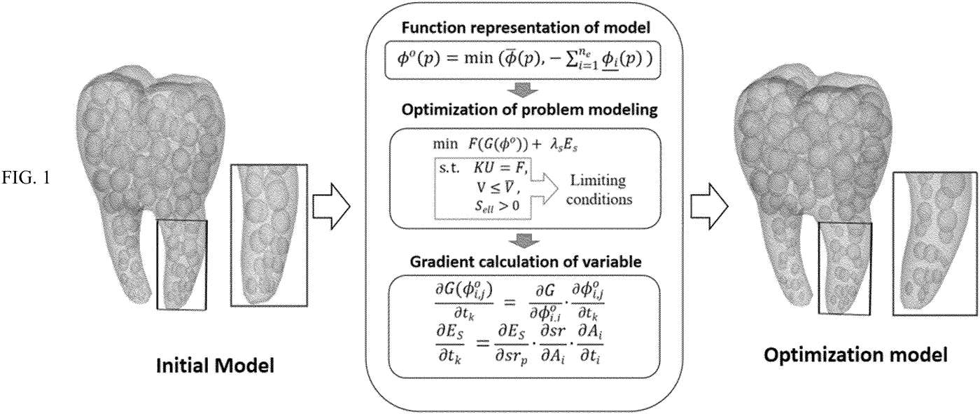

FIG. 2 is a result diagram of design and optimization based on a self supporting ellipsoidal cavity structure, (a) is a tangent plane for stress analysis of a model, (b) is a tangent plane of an initial model, (c) is stress analysis of a model, (d) is an initial model, and (e) is an optimized model.

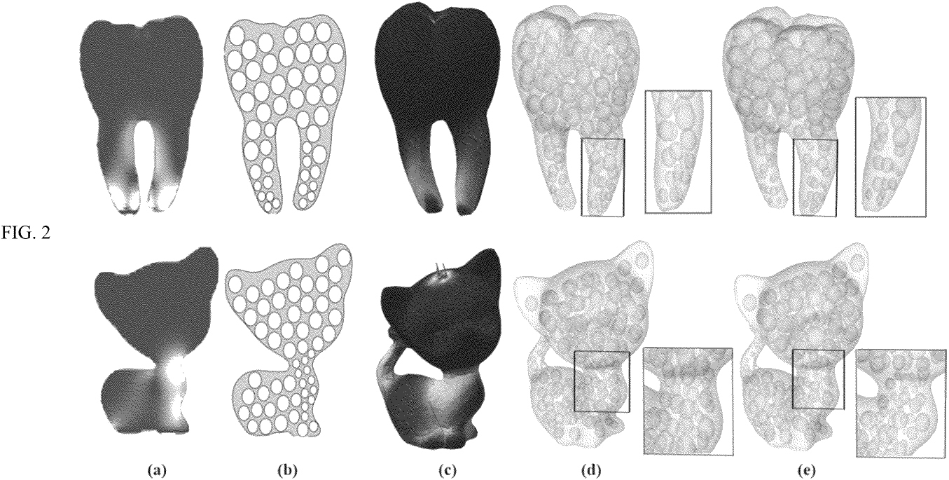

### DETAILED DESCRIPTION

Specific embodiments of the present invention are further described below in combination with the drawings and the technical solution.

The implementation of the present invention can be specifically divided into the main steps of function presentation of an ellipsoidal cavity structure, initialization of a self supporting ellipsoidal cavity model, establishment and discretization of a stress problem optimization model, and an optimization process.

### (I) Presentation of Ellipsoidal Cavity Structure

First, the outer surface of a model is described by a radial basis function, and represented as follows:

$$\overline{ϕ} \left(p\right) = {\sum }_{i = 1}^{{n}_{c}} {a}_{i} {R}_{i} \left(p\right) + Q \left(p\right)$$

wherein ϕ̅(p) is an outer surface function of the model, Rᵢ(p) = R(|Pᵢ - Pⱼ|) is a radial basis function which represents the distance between points Pᵢ and Pⱼ,

$${\left\{{P}_{i}\right\}}_{i = 1}^{{n}_{c}}$$

is to uniformly sample on the outer surface of the model, n_{c} is the number of control points, with the value of [200,500], Q(p) = b₁x + b₂y + b₃z + b₄ is a linear polynomial, aᵢ is the weight of Rᵢ(p), and bᵢ is the weight in the linear polynomial Q(p).

The ellipsoidal cavities in the model are directly described by an ellipsoidal function, and represented as follows:

$$\underline{{ϕ}_{i}} \left(p\right) = \frac{{\left(x - {x}_{0}^{i}\right)}^{2}}{{a}_{i}^{2}} + \frac{{\left(y - {y}_{0}^{i}\right)}^{2}}{{b}_{i}^{2}} + \frac{{\left(z - {z}_{0}^{i}\right)}^{2}}{{c}_{i}^{2}}$$

wherein

$$\underline{{ϕ}_{i}} \left(p\right)$$

represents the inner surface function of the i ^{th} ellipsoidal cavity,

$$\left({x}_{0}^{i} , {y}_{0}^{i} , {z}_{0}^{i}\right)$$

is the coordinate of the center point of the i ^{th} ellipsoid, and (a_{i,} bᵢ, cᵢ) are respectively three semi-axes of the i ^{th} ellipsoid.

Boolean operation is performed on the inner and outer surfaces of the model, the obtained three-dimensional model with ellipsoidal cavities is represented as ϕ°(p) ≥ 0, and ϕ°(p) is a representation function of the model;

$${ϕ}^{∘} \left(p\right) = min \left(\overline{ϕ} \left(p\right) , - {\sum }_{i = 1}^{{n}_{e}} \underline{{ϕ}_{i}} \left(p\right)\right)$$

wherein p = (x, y, z) is the coordinate of a point on the model, ϕ°(p) is a representation function of the model, ϕ̅(p) is an outer surface function of the object,

$$\underline{{ϕ}_{i}} \left(p\right)$$

is an inner surface function of the i ^{th} ellipsoid, and nₑ is the number of ellipsoids. To overcome non-continuity caused by Boolean operation, the formula (2.3) is rewritten and represented as follows:

$${ϕ}^{∘} \left(p\right) = \overline{ϕ} \left([\right) + {\sum }_{i = 1}^{{n}_{e}} \underline{{ϕ}_{i}} \left(p\right) = \sqrt{\overline{ϕ} {\left(p\right)}^{2} + {\sum }_{i = 1}^{{n}_{e}} \underline{{ϕ}_{i}} {\left(p\right)}^{2}}$$

### (II) Initialization and Structure Optimization Based on Self Supporting Ellipsoidal Cavity Model

### 1. Initialization of Self Supporting Ellipsoidal Cavity Model

### 1.1 Self Supporting Conditions of Ellipsoid

Self supporting structure refers to a geometric shape that can be printed layer by layer without additional support. Self supporting is realized when the overhanging angle of the model surface is less than the maximum specified overhanging angle, and an ellipsoidal structure is used to better control the change of the angle to satisfy the self supporting conditions.

For ellipsoids, the print direction of the model is determined first, and with printing in the z-axis direction as an example, the self supporting conditions of ellipsoids are as follows:

$$\left\{\begin{matrix}a \leq c , i f 5 σ \leq a \leq \frac{{δ}_{0}}{2 c o s {θ}_{0}} \\ b \leq c , i f 5 σ \leq b \leq \frac{{δ}_{0}}{2 c o s {θ}_{0}} \\ c \geq a \frac{\sqrt{4 {a}^{2} - {δ}_{0} {}^{2}}}{{δ}_{0} t a n {θ}_{0}} , i f a \geq \frac{{δ}_{0}}{2 c o s {θ}_{0}} \left(2.5\right) \\ c \geq b \frac{\sqrt{4 {b}^{2} - {δ}_{0} {}^{2}}}{{δ}_{0} t a n {θ}_{0}} , i f b \geq \frac{{δ}_{0}}{2 c o s {θ}_{0}}\end{matrix}\right)$$

wherein c is a semi-axis corresponding to the print direction, a, b are semi-axes corresponding to the non-printing direction, σ is the thickness of each layer of material during additive printing, with the value range of [0.1 mm, 0.5 mm], δ₀ is the maximum overhanging horizontal length for printing, depending on the density and viscosity of the printing material, with the value range of [1 mm, 5 mm], the maximum overhanging horizontal length for printing of the frequently-used PLA material is 5 mm, θ₀ is the maximum specified overhanging angle, depending on the properties of the material, with the angle range of [45°, 60°], θ₀ = 60° for the PLA material, and when the semi-axes corresponding to the non-printing direction and the semi-axis corresponding to the print direction of an ellipsoid satisfy the above self supporting conditions, the ellipsoid is a self supporting ellipsoid.

### 1.2 Non-Intersect Conditions of Ellipsoid

Matrix forms of any two ellipsoids are represented as X^{T}A₁^{X} = 0, X^{T}A₂X = 0, wherein X is a coordinate vector matrix, A₁ and A₂ are corresponding diagonal matrices, and the condition for two ellipsoids not to intersect is that two unequal positive roots exist when the value of the function

$$f \left(λ\right) = \frac{d e t \left(λ {A}_{1} + {A}_{2}\right)}{d e t \left({A}_{1}\right)}$$

is zero. ƒ(λ) can be equivalently represented as a quad polynomial with the highest-degree coefficient of 1:

$$f \left(λ\right) = {λ}^{4} + α {λ}^{3} + β {λ}^{2} + γ + δ$$

wherein the coefficients {α,β,γ,δ} are determined by the parameter matrices A₁,A₂ of the ellipsoid.

The condition for two ellipsoids not to intersect is equivalently represented as φ = 2, sr₂₂ > 0, sr₁₁ > 0, sr₀ > 0 or φ = 2, sr₂₂ > 0, sr₁₁ > 0, sr₁₀ > 0, sr₀ = 0, represented as follows:

$$\left\{\begin{matrix}s {r}_{22} = 3 {α}^{2} - 8 β \\ s {r}_{11} = - 6 {α}^{3} γ + 2 {α}^{2} {β}^{2} - 12 {α}^{2} δ + 28 α β γ - 8 {β}^{3} - 36 {γ}^{2} + 32 β δ \\ s {r}_{10} = 9 {α}^{3} δ + {α}^{2} β γ + 3 α {γ}^{2} + 32 α β δ - 4 {β}^{2} - 48 γ δ \\ s {r}_{0} = - 192 γ {δ}^{2} α + 256 {δ}^{3} + 144 {γ}^{2} δ β + {β}^{2} {α}^{2} {γ}^{2} - 6 {γ}^{2} δ {α}^{2} \\ + 18 {γ}^{3} β α + 144 β {α}^{2} {δ}^{2} - 4 {β}^{3} {α}^{2} δ + 16 {β}^{4} δ - 4 {γ}^{3} {α}^{3} \\ - 27 {α}^{4} {δ}^{2} - 80 α γ δ {β}^{2} + 18 {α}^{3} β γ δ - 27 {γ}^{4}\end{matrix}\right)$$

wherein φ represents the number of {1,α,β,γ,δ} sign symbol changes, and parameters sr₂₂, sr₁₁, sr₁₀, sr₀ depend on the parameter matrices A₁,A₂

### 1.3 Initialization of Self Supporting Ellipsoidal Cavity Model

For given model stress and boundary conditions, a stress problem model is established as follows:

$${}_{{t}_{k}}^{}{m} i n I = {\int }_{{\text{Ω}}_{M}} G \left({ϕ}^{O} \left(p\right)\right) F ⋅ u d V + {\int }_{{τ}_{S}} {F}_{S} ⋅ u d S$$

$$s . t . {\int }_{{\text{Ω}}_{M}} G \left({ϕ}^{O} \left(p\right)\right) : ε \left(u\right) : ε \left(v\right) d {V}_{M}$$

$$= {\int }_{{\text{Ω}}_{M}} G \left({ϕ}^{O} \left(p\right)\right) f ⋅ v d V + {\int }_{{τ}_{S}} s ⋅ v d S , ∀ v ε {U}_{a d}$$

$$u = \overline{u} , o n {τ}_{u}$$

$${\int }_{{\text{Ω}}_{M}} G \left({ϕ}^{O} \left(p\right)\right) d {V}_{M} \leq {V}_{C}$$

wherein

$${t}_{k} = \left\{{a}_{1} , {b}_{1} , {c}_{1} , ... , {a}_{{n}_{e}} , {b}_{{n}_{e}} , {c}_{{n}_{e}}\right\} \left(k = 1 , ... , {3}_{{n}_{e}}\right)$$

is the set of three axial length variable parameters of an ellipsoid, I is the overall compliance, Ω_{M} is the whole region occupied by the model M, ϕ°(∗) is a representation function of the model, F is a body force, Fₛ is a surface force defined on the Riemann boundary τₛ, S is the area of the Riemann boundary τₛ, u is a displacement field, v is a test function defined on the region Ω_{M}, U_{ad} = {vlv ∈ Sob¹(Ω_{M}), ν = 0 on τᵤ}, Sob¹ is the first order soblev space, ε is the second order linear strain tensor,

$$E$$

is the fourth order elastic tensor, u̅ is a displacement constraint defined on the Dirichlet boundary τᵤ, V_{M} is the volume of the model M, V_{c} is the value of a volume constraint, and G(x) is a regularized Heaviside function, represented as follows:

$$G \left(x\right) = \left\{\begin{matrix}1 , & i f x > β , \\ \frac{3 \left(1 - α\right)}{4} \left(\frac{x}{β} - \frac{{x}^{3}}{3 {β}^{3}}\right) + \frac{\left(1 + α\right)}{2} , & i f - β \leq x \leq β , \\ α , & i f \text{} x < - β ,\end{matrix}\right)$$

wherein α, β are threshold parameters, α = 0.01 and β = 0.001.

For an ellipsoidal cavity model initially generated, the optimization goal is satisfied. i.e., the ellipsoidal cavity is larger where the stress is small, reducing internal solid space and material consumption; and the ellipsoidal cavity is smaller where the stress area is large, increasing internal solid space and resisting deformation caused by stress. Meanwhile, the ellipsoidal cavity model initially generated needs further optimization to continue optimization of the cavity volume to the set target volume under the limitation of ensuring that the internal ellipsoidal structure can realize self supporting and non-intersect.

First, a three-dimensional bounding box is built for the model. Then, the inner space of the bounding box is subjected to uniform mesh generation, and the whole three-dimensional space is divided into uniform meshes with K³ mesh points. Each mesh point is taken as an internal initial ellipsoid center for screening. A corresponding ellipsoid radius rₙ(n = 1... K³) is assigned to each internal initial ellipsoid center according to the stress value of the region of each internal initial ellipsoid center. To enhance the flexibility when the inner space is initialized so as to make the ellipsoids fill the whole space, the ellipsoid radius corresponding to each center point varies within a range.

The ellipsoid radius satisfies here

$${\text{r}}_{max}^{\text{i}} = {μ}_{i} ∗ min \left\{\frac{\text{XMax} \text{-XMin}}{g} , \frac{\text{YMax} \text{-Ymin}}{g} , \frac{\text{ZMax} \text{-} \text{ZMin}}{g}\right\}$$

wherein XMax, XMin, YMax, YMin, ZMax and ZMin are extreme values of the model in three dimensions; g is a density parameter, used for adjusting the number of internal ellipsoids, as the g value gradually increases, the ellipsoid radius decreases, the number of ellipsoidal cavities in the model increases, and the initial cavity volume increases; and µᵢ is the stress parameter of the point, represented as follows:

$${μ}_{i} = \frac{1}{{D}_{i} B}$$

wherein B is a strain matrix, Dᵢ is an elastic matrix of the i^{th} unit, Dᵢ = ρᵢD₀, the Young’s modulus D₀ depends on the attributes of the solid material used, and ρᵢ is the density of the i^{th} unit.

$${ρ}_{i} = \frac{1}{8} {\sum }_{j = 1}^{8} \left(G {\left({ϕ}_{i , j}^{o}\right)}^{q}\right)$$

wherein G (x) is a regularized Heaviside function, is the model function value of the j^{th} vertex of the i^{th} unit, q is a penalty parameter, G(_{*}) is regularized to ensure the stability of the problem and the existence of the optimal solution, and generally, q = 2.

### 2. Optimization of Self Supporting Ellipsoidal Cavity Model Structure

### 2.1 Stress Problem Optimization Model

During optimization of the initialized self supporting ellipsoidal cavity model, the stress problem model can be represented as an optimization model in a discrete form by introducing an auxiliary variable Eₛ into the target function and introducing self supporting conditions into the limiting conditions:

$$min I = {U}^{T} K U + {λ}_{S} {E}_{S}$$

$$\text{s} \text{.} \text{t} \text{.} K U = F ,$$

$$\text{V} \text{=} {\sum }_{\text{i=1}}^{\text{n}} {\sum }_{\text{j} \text{=1}}^{8} \left(G {\left({ϕ}_{i , j}^{o}\right)}^{q}\right) - {\sum }_{\text{i=} \text{1}}^{{\text{n}}_{\text{e}}} \frac{4}{3} π {a}_{i} {b}_{i} {c}_{i} \leq \overline{V} ,$$

$$a \left(b\right) \leq c , i f 5 σ \leq a \left(b\right) \leq \frac{{δ}_{0}}{2 c o s {θ}_{0}} ,$$

$$c \geq a \left(b\right) \frac{\sqrt{4 a {\left(b\right)}^{2} - {δ}_{0} {}^{2}}}{{δ}_{0} t a n {θ}_{0}} , i f a \left(b\right) \geq \frac{{δ}_{0}}{2 c o s {θ}_{0}}$$

wherein the purpose of introducing the auxiliary variable Eₛ is to keep the ellipsoids in a non-intersect state during optimization, λ_{S}is a target weight, U is a displacement matrix, U^{T} is the transposition of the displacement matrix, F is an applied external force, K is the stiffness matrix of the material, which is composed of the stiffness matrix Kᵢ of each unit, and Kᵢ is represented as follows:

$${K}_{i} = {\int }_{{Ω}_{i}} {B}^{T} {D}_{i} B d V$$

wherein B is a strain matrix, B^{T} is an inverse matrix of the strain matrix, Ωᵢ is the region occupied by the i^{th} unit, and Dᵢ is an elastic matrix of the i^{th} unit.

During optimization, the ellipsoids shall not intersect, and the target can be represented as follows:

$${E}_{S} = \left\{\begin{matrix}0 , i f ϕ = 2 , s {r}_{22} > 0 , s {r}_{11} > 0 , s {r}_{0} > 0 \left(o r s {r}_{0} = 0 , s {r}_{10} > 0\right) \\ \left|s {r}_{22}\right| + \left|s {r}_{11}\right| + \left|s {r}_{10}\right| + \left|s {r}_{0}\right| , \text{otherwise} \left(2.15\right)\end{matrix}\right)$$

wherein φ represents the number of {1,α,β,γ, δ} sign symbol changes, and parameters sr₂₂, sr₁₁, sr₁₀, sr₀ depend on the parameter matrices A₁, A2.

### 2.2 Analytic Calculation and Optimization

Based on the optimization problems established above, the solving algorithm is used for optimization, wherein the variable parameters are the semi-axes of all the ellipsoids, nₑ is the number of the internal ellipsoids, the target function is the overall compliance I, the limiting conditions are self supporting conditions, cavity volume limitations and external force balance of ellipsoids, and the gradient relative to the parameter variables is calculated as follows:

$$\begin{matrix}\frac{\partial I}{\partial {t}_{k}} = - {U}^{T} \frac{\partial K}{\partial {t}_{k}} U + {λ}_{S} \frac{\partial {E}_{S}}{\partial {t}_{k}} \\ = - {U}^{T} \left[\frac{1}{8} {\sum }_{i = 1}^{n} {\sum }_{j = 1}^{8} q {\left(G \left({ϕ}_{i , j}^{o}\right)\right)}^{q - 1} \frac{\partial G \left({ϕ}_{i , j}^{o}\right)}{\partial {t}_{k}}\right] U + {λ}_{s} \frac{\partial {E}_{S}}{\partial {t}_{k}} ,\end{matrix}$$

and

$$\frac{\partial V}{\partial {t}_{k}} = {\sum }_{k = 1}^{{n}_{e}} \frac{4}{3} π \frac{{a}_{k} {b}_{k} {c}_{k}}{{t}_{k}}$$

where

$$\frac{\partial G \left({ϕ}_{i , j}^{o}\right)}{\partial {t}_{k}} = \frac{\partial G}{\partial {ϕ}_{i , j}^{o}} \cdot \frac{\partial {ϕ}_{i , j}^{o}}{\partial {t}_{k}}$$

$$\frac{\partial {E}_{S}}{\partial {t}_{k}} = \frac{\partial {E}_{s}}{\partial s {r}_{p}} \cdot \frac{\partial s r}{\partial {A}_{i}} \cdot \frac{\partial {A}_{i}}{\partial {t}_{k}}$$

wherein λₛ is a target weight, U is a displacement matrix, U^{T} is the transposition of the displacement matrix, K is the stiffness matrix of the material, Eₛ is an auxiliary variable for controlling intersection of ellipsoids, q is a penalty parameter, G(x) is a regularized Heaviside function, is a representation function of the model with ellipsoidal cavities, tₖ is the set of variable parameters: is the set of intermediate parameters, and Aᵢ is a parameter matrix in the matrix form of the i^{th} ellipsoid.

The calculated gradient is substituted into a solver to obtain an optimal value thus obtaining the final optimization model, i.e., the internal shape of the object optimized under given constraint conditions.

1. A design and optimization method based on a self supporting ellipsoidal cavity structure, comprising the following steps:
(1) shape function representation of three-dimensional model with ellipsoidal cavities:
representing a three-dimensional model with ellipsoidal cavities as ø°(p) ≥ 0, wherein ø°(p) is a representation function of the model:
$${ϕ}^{o} \left(p\right) = min \left(\overline{ϕ} \left(p\right) , - {\sum }_{i = 1}^{{n}_{e}} {\underline{ϕ}}_{i} \left(p\right)\right)$$
wherein p = (x, y, z) is the coordinate of a point on the model, ø̅(p) is an outer surface function of an object, øᵢ(p) is an inner surface function of the i^{th} ellipsoid, and nₑ is the number of ellipsoids;
(2) initialization and structure optimization based on self supporting ellipsoidal cavity model
(2.1) initialization of self supporting ellipsoidal cavity model
first, building a three-dimensional bounding box for the model; then, conducting uniform mesh generation for the inner space of the three-dimensional bounding box, wherein the whole three-dimensional space is divided into uniform meshes with K³ mesh points; taking each mesh point as an internal initial ellipsoid center for screening; and assigning a corresponding ellipsoid radius rₙ, n = 1... K³ to each internal initial ellipsoid center according to the stress value of the region of each internal initial ellipsoid center, wherein the ellipsoid radius corresponding to each center point varies within a range to enhance the flexibility when the inner space is initialized, so as to make the ellipsoids fill the whole space;
the ellipsoid radius corresponding to the i^{th} center point is
$${r}_{n}^{i} ∈ \left[0.5 {r}_{m a x}^{i} , {r}_{m a x}^{i}\right] ,$$
the value of the ellipsoid radius is determined from large to small in actual use, and
$${r}_{m a x}^{i}$$
is represented as follows:
$${\text{r}}_{\text{max}}^{\text{i}} = {μ}_{i} ∗ min \left\{\frac{\text{XMax} - \text{XMin}}{g} \text{,} \frac{\text{YMax} - \text{YMin}}{g} \text{,} \frac{\text{ZMax} - \text{ZMin}}{g}\right\}$$
wherein XMax, XMin, YMax, YMin, ZMax and ZMin are extreme values of the model in three dimensions; g is a density parameter, used for adjusting the number of internal ellipsoids; and µᵢ is a stress parameter of the point, represented as follows:
$${μ}_{i} = \frac{1}{{D}_{i} B}$$
wherein B is a strain matrix; Dᵢ is an elastic matrix of the i^{th} unit; Dᵢ = ρᵢD₀, and the Young’s modulus D₀ depends on the attributes of the solid material used; and ρᵢ is the density of the i^{th} unit;
(2.2) establishment of problem model
for given model stress and boundary conditions, establishing a stress problem model as follows:
$${}_{{t}_{k}} min I = {\int }_{{\text{Ω}}_{M}} G \left({ϕ}^{o} \left(p\right)\right) F ⋅ u d {V}_{M} + {\int }_{{τ}_{S}} {F}_{s} ⋅ u d S$$
$$\begin{matrix}s . t . {\int }_{{\text{Ω}}_{M}} G \left({ϕ}^{o} \left(p\right)\right) E : ε \left(u\right) ; ε \left(v\right) d {V}_{M} \\ = {\int }_{{\text{Ω}}_{M}} G \left({ϕ}^{o} \left(p\right)\right) f ⋅ v d {V}_{M} + {\int }_{{τ}_{S}} s ⋅ v d S , ∀ v ∈ {U}_{a d}\end{matrix}$$
$$u = \overline{u} , o n {τ}_{u}$$
$${\int }_{{\text{Ω}}_{M}} G \left({ϕ}^{o} \left(p\right)\right) d {V}_{M} \leq {V}_{c}$$
wherein
$${t}_{k} = \left\{{a}_{1} , {b}_{1} , {c}_{1} , ... , {a}_{{n}_{e}} , {b}_{{n}_{e}} , {c}_{{n}_{e}}\right\} \left(k = 1 , ... , 3 {n}_{e}\right)$$
is the set of three axial length variable parameters of an ellipsoid, I is the overall compliance, Ω_{M} is the whole region occupied by the model M, ø°(_{*}) is a representation function of the model, F is a body force, Fₛ is a surface force defined on the Riemann boundary τₛ, S is the area of the Riemann boundary τₛ, u is a displacement field, v is a test function defined on the region Ω_{M}, U_{ad} = {v|v ∈ Sob¹(Ω_{M}),v= 0 on τᵤ}, Sob¹ is the first order soblev space, ε is the second order linear strain tensor, ƒ is a body force acting on the model, s is a surface force defined on the Riemann boundary τ ₛ, E is the fourth order elastic tensor, u̅ is a displacement constraint defined on the Dirichlet boundary τᵤ, V_{M} is the volume of the model M, V_{c} is the value of a volume constraint, and G (x) is a regularized Heaviside function;
(2.3) discretization of problem model;
for optimization of the initialized self supporting ellipsoidal cavity model, after introducing an auxiliary variable Eₛ for preventing ellipsoids from intersecting into the stress problem model and introducing self supporting conditions into the limiting conditions, representing the stress problem model as an optimization model in a discrete form;
$$min I = {U}^{T} K U + {λ}_{S} {E}_{S}$$
$$\text{s} . \text{t} . K U = F ,$$
$${V}_{M} = {\sum }_{\text{i} = 1}^{\text{n}} {\sum }_{\text{j} = 1}^{8} \left(G {\left({ϕ}_{i , j}^{o}\right)}^{q}\right) - {\sum }_{\text{i} = 1}^{{\text{n}}_{\text{e}}} \frac{4}{3} π {a}_{i} {b}_{i} {c}_{i} \leq {V}_{c} ,$$
$$a \left(b\right) \leq c \text{} , i f 5 σ \leq a \left(b\right) \leq \frac{{δ}_{0}}{2 c o s {θ}_{0}} ,$$
$$c \geq a \left(b\right) \frac{\sqrt{4 a {\left(b\right)}^{2} - {δ}_{0} {}^{2}}}{{δ}_{0} t a n {θ}_{0}} , i f a \left(b\right) \geq \frac{{δ}_{0}}{2 c o s {θ}_{0}}$$
wherein the purpose of introducing the auxiliary variable Eₛ is to keep the ellipsoids in a non-intersect state during optimization, λₛ is a target weight, U is a displacement matrix, U^{T} is the transposition of the displacement matrix, F is an applied external force, K is the stiffness matrix of the material, which is composed of the stiffness matrix Kᵢ of each unit, a_{i,} b_{i,} cᵢ are respectively variable parameters of three semi-axes of an ellipsoid, G (x) is a regularized Heaviside function, q is a penalty parameter, V_{M} is the volume of the model M, V_{c} is the value of a volume constraint, a(b) are two semi-axes of the ellipsoid in the non-printing direction, c is the semi-axis of the ellipsoid in the print direction, σ is the thickness of each layer of material during additive printing, δ₀ is the maximum overhanging horizontal length for printing, and θ₀ is the maximum specified overhanging angle;
(2.4) Modeling problem optimization
based on the optimization problems established above, using the solving algorithm for optimization, wherein the variable parameters are the semi-axes
$${\left\{\left({a}_{k} , {b}_{k} , {c}_{k}\right)\right\}}_{k = 1}^{{n}_{e}}$$
of all the ellipsoids, nₑ is the number of the ellipsoids, the target function is the overall compliance I, the limiting conditions are self supporting conditions, cavity volume limitations and external force balance of ellipsoids, and the gradient relative to the parameter variables is calculated as follows:
$$\begin{matrix}\frac{\partial I}{\partial {t}_{k}} = - {U}^{T} \frac{\partial K}{\partial {t}_{k}} U + {λ}_{S} \frac{\partial {E}_{S}}{\partial {t}_{k}} \\ = - {U}^{T} \left[\frac{1}{8} {\sum }_{i = 1}^{n} {\sum }_{j = 1}^{8} q {\left(G \left({ϕ}_{i , j}^{o}\right)\right)}^{q - 1} \frac{\partial G \left({ϕ}_{i , j}^{o}\right)}{\partial {t}_{k}}\right] U + {λ}_{S} \frac{\partial {E}_{S}}{\partial {t}_{k}} ,\end{matrix}$$
and
$$\frac{\partial {V}_{M}}{\partial {t}_{k}} = {\sum }_{k = 1}^{{n}_{e}} \frac{4}{3} π \frac{{a}_{k} {b}_{k} {c}_{k}}{{t}_{k}}$$
$$\frac{\partial G \left({ϕ}_{i , j}^{o}\right)}{\partial {t}_{k}} = \frac{\partial G}{\partial {ϕ}_{i , j}^{o}} ⋅ \frac{\partial {ϕ}_{i , j}^{o}}{\partial {t}_{k}}$$
$$\frac{\partial {E}_{S}}{\partial {t}_{k}} = \frac{\partial {E}_{S}}{\partial s {r}_{p}} ⋅ \frac{\partial s {r}_{p}}{\partial {A}_{i}} ⋅ \frac{\partial {A}_{i}}{\partial {t}_{k}}$$
wherein λₛ is a target weight, U is a displacement matrix, U^{T} is the transposition of the displacement matrix, K is the stiffness matrix of the material, Eₛ is an auxiliary variable, [symbol] is a presentation function of the model with ellipsoidal cavities, tₖ is the set of variable parameters:
$${t}_{k} = \left\{{a}_{1} , {b}_{1} , {c}_{1} , ... , {a}_{{n}_{e}} , {b}_{{n}_{e}} , {c}_{{n}_{e}}\right\} \left(k = 1 , ... , {n}_{e}\right) ,$$
nₑ is the number of ellipsoids in the model, q is a penalty parameter, G(x) is a regularized Heaviside function, n is the number of inner elements, srₚ is the set of intermediate parameters, and Aᵢ is a parameter matrix in the matrix form of the i^{th} ellipsoid; and the calculated gradient is substituted into a solver to obtain an optimal value [symbol] thus obtaining the final optimization model, i.e., the internal shape of the object optimized under given constraint conditions.
